(19) United States
(12) Patent Application Publication
(10) Pub. No.: US 2026/0262610 A1
(43) Pub. Date: Sep. 10, 2026

(54) INTELLIGENT SWITCHING SYSTEM FOR PET WALKING AND METHOD THEREOF

(71) Applicant: Guangzhou Lansheng Technology Co., Ltd, Tianhe District (CN)

(72) Inventor: Huansheng Yu, Tianhe District (CN)

(73) Assignee: Guangzhou Lansheng Technology Co., Ltd, Tianhe District (CN)

(21) Appl. No.: 19/070,282

(22) Filed: Mar. 4, 2025

(51) Int. Cl. A01K 29/00; A01K 23/00

(52) U.S. Cl. CPC A01K 29/005; A01K 23/005

(57) ABSTRACT

The present invention discloses an intelligent switching system for pet walking and method thereof, wherein the system comprises a hardware module, a pet walking software, a cloud and a mobile terminal. The method to use includes step 1 which is initialization, step 2 which is turning on function of pet walking, step 3 which is turning off the function of pet walking and step 4 which is uploading pet walking data. The present invention combines NFC, Bluetooth and QR code technologies with hardware carriers, so that users can automatically switch the function of the pet walking by simply touching or scanning the hardware carriers by using mobile terminal, thereby solving the problem of cumbersome operation of the existing pet walking software, saving users' time and energy, and effectively improving convenience and enhancing user experience.

### TECHNICAL FIELD

The present invention relates to the technical field of pet supplies and specifically relates to an intelligent switching system for pet walking and method thereof.

### TECHNICAL BACKGROUND

With improvement of people's living standards, the status of pets in the family is becoming increasingly important, while pet walking has become an important activity in the process of pet breeding. In the prior art, pet walking software is generally used to record data of pet walking, but existing pet walking software is very cumbersome to use and lacks convenience. Users are usually required to turn on the pet walking function through the following steps. Users first download and install a pet walking software by opening app store on a mobile phone, then open a pet walking software and find a pet walking function module in main interface or menu of the software. Finally, click the module to enable the pet walking function. When the pet walking function needs to be paused or ended, the mobile phone must be operated to re-enter the pet walking function module for operation. Therefore, this operation method has problems of being cumbersome, time-consuming and having poor user experience. additionally, existing pet walking software not only lack in-depth analysis of pet walking data, but also cannot assess the health status of pets and cannot provide reasonable suggestions for pet walking activities. Based on this, the present intelligent switching system for pet walking and method is proposed.

### SUMMARY OF THE INVENTION

The present invention provides an intelligent switching system for pet walking and method thereof to solve the problems raised in the prior art.

To achieve the above-mentioned objectives, the technical solution adopted by the present invention is as follows:

The present invention provides an intelligent switching system for pet walking, comprising a hardware module, a pet walking software, a cloud as well as a mobile terminal, wherein the mobile terminal is installed with a pet walking software which establishes data connections with the hardware module and the cloud respectively, the hardware module comprises a carrier submodule as well as a multi-signal trigger submodule, and the multi-signal trigger submodule is installed on the carrier submodule and establishes a data connection with the pet walking software.

The carrier submodule is one of a waste bag dispenser, a pet leash or a pet tag, the waste bag dispenser comprises a storage bin, a material taking port, a first end cap and a second end cap, the storage bin is provided with the material taking port, one end of storage bin is fixedly connected with the first end cap, and the other end of the storage bin is fixedly connected with the second end cap.

The multi-signal trigger submodule is one or more combinations of NFC unit, Bluetooth unit and QR code unit, the Bluetooth unit comprises a Bluetooth body, a controller, and a power supply.

The pet walking software comprises a device connection management submodule, a personalized setting submodule, a command receiving and a processing submodule, a pet information input submodule and a pet walking function interface submodule, the device connection management submodule is used to establish a data connection with the multi-signal trigger submodule, parses the content of signal and obtain instructions, the personalized setting submodule is used to personalize the pet walking software, the command receiving and processing submodule is used to receive instructions parsed by the device connection management submodule, performs links jump and control the pet walking function interface submodule. The pet information input submodule is used to type in the pet information, and the pet walking function interface submodule is used to provide pet walking services.

The pet walking function interface submodule comprises pet walking path display unit, defecation and urination recording unit, pet walking time statistics unit, pet walking distance statistics unit and calorie consumption calculation unit. The pet walking path display unit is used to display the pet walking path on electronic map, defecation and urination recording unit is used to type in the information of the pet's defecation and urination. The pet walking time statistics unit is used to count the pet walking time, the pet walking distance statistics unit is used to count the pet walking distance, and the calorie consumption calculation unit is used to calculate the calories consumed by the pet.

The cloud is provided with a data storage submodule, a user community submodule and a data mining submodule. The data storage submodule is used to store data, the user community submodule is used to provide pet community forum services, and data mining submodule is used to deeply excavate the data.

The data mining submodule comprises a pet health analysis unit and an optimal pet walking time analysis unit. The pet health analysis unit analyzes health status of pets through big data, and the optimal pet walking time analysis unit generates recommendation on the pet walking time based on health status of the pet.

Method for intelligently switching the function of pet walking, comprising multiple steps. Step 1 is initialization, step 2 is turning on the function of pet walking, step 3 is turning off the function of pet walking and step 4 is uploading pet walking data.

The pet walking software is installed in the mobile terminal, an account is registered and logged in to the pet walking software, and then the pet information is completed in the step 1.

The data connection is established between the mobile terminal and the multi-signal trigger submodule. The multi-signal trigger submodule sends a start signal to the pet walking software, and then the pet walking software switches to pet walking function interface submodule to start the function of pet walking function in the step 2.

The data connection is established between the mobile terminal as well as multi-signal trigger submodule. The multi-signal trigger submodule sends end signal to the pet walking software, and then the pet walking software ends the function of pet walking in the step 3.

The pet walking software automatically uploads the pet walking data to the cloud after the pet walking function is ended in the step 4.

The Pet information in step 1 comprises a pet's gender, age, type and weight.

After the pet walking data is uploaded to the cloud in step 4, the cloud will store data, analyze health status of pets and best time for pet walking, and simultaneously send analysis results to the mobile terminal.

The beneficial effects of technical solutions of the present disclosure compared with prior art are as follows:

The present disclosure combines the NFC, Bluetooth and QR code technologies with hardware carriers, users can automatically switch the function of the pet walking by simply touching or scanning the hardware carriers by using mobile terminal, thereby solving the problem of the cumbersome operations of existing pet walking software, saving the users' time and energy, and effectively improving convenience and enhancing user experience, so the users can enjoy the fun of pet walking without the cumbersome operations of existing pet walking systems. After the pet walking is completed, the pet walking data will be automatically uploaded to the cloud, which will evaluates the health status of the pet through in-depth data mining and give the recommendation of best pet walking time accordingly.

### DESCRIPTION OF DRAWINGS

FIG. 1 shows a structural block diagram of system of the present invention.

FIG. 2 shows a structural block diagram of the carrier submodule of the present invention.

FIG. 3 shows a structural block diagram of the multi-signal trigger submodule of the present invention.

FIG. 4 shows a structural block diagram of the Bluetooth unit of the present invention.

FIG. 5 shows a structural block diagram of the pet walking software of the present invention.

FIG. 6 shows a structural block diagram of the pet walking function interface submodule of the present invention.

FIG. 7 shows a structural block diagram of the cloud of the present invention.

FIG. 8 shows a structural block diagram of the data mining submodule of the present invention.

FIG. 9 shows a schematic diagram of the three-dimensional structure of waste bag dispenser of the present invention.

FIG. 10 shows a flow chart of the method of the present invention.

Among them: 1. Hardware module; 11. Carrier submodule; 111. Waste bag dispenser; 1111. Storage bin; 1112. Material taking port; 1113. First end cap; 1114. Second end cap; 112. Pet leash; 113. Pet tag; 12. Multi-signal trigger submodule; 121. NFC unit; 122. Bluetooth unit; 1221. Bluetooth body; 1222. Controller; 1223. Power supply; 123. QR code unit; 2. Pet walking software; 21. Device connection management submodule; 22. Personalized setting submodule; 23. Command receiving and processing submodule; 24. Pet information input submodule; 25. Pet walking function interface submodule 251. Pet walking path display unit; 252. Defecation and urination recording unit; 253. Pet walking time statistics unit; 254. Pet walking distance statistics unit; 255. Calorie consumption calculation unit; 3. cloud; 31. Data storage submodule; 32. User community submodule; 33. Data mining submodule; 331. Pet health analysis unit; 332. Optimal pet walking time analysis unit; 4. Mobile terminal.

### DETAILED DESCRIPTION OF THE EMBODIMENTS

The technical solution in embodiments of present invention will be described below in combination with the attached drawings in embodiments of present invention. Obviously, the embodiments described are only part of the embodiments of the present invention, not all embodiments.

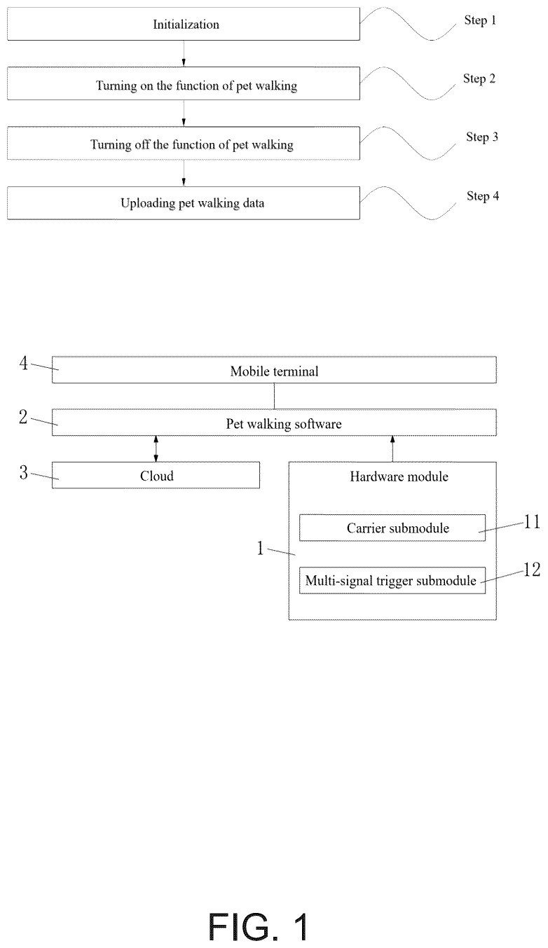

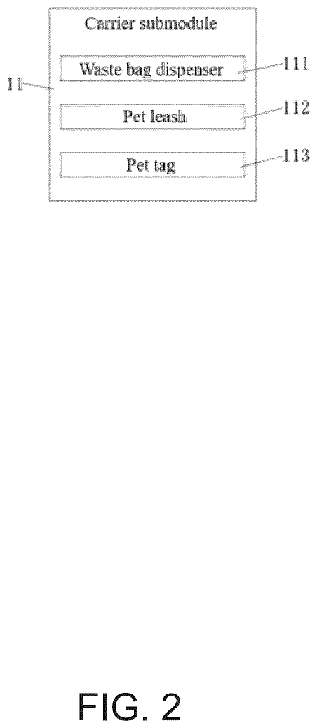

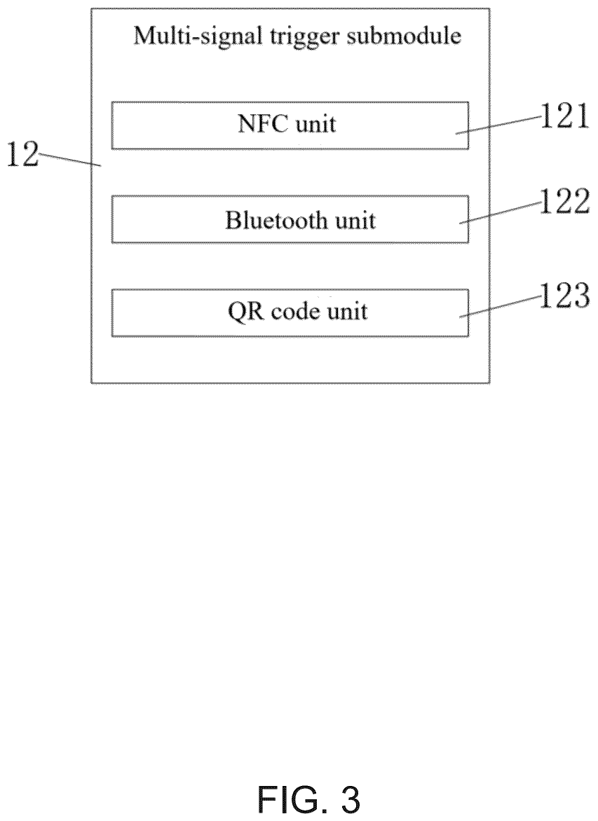

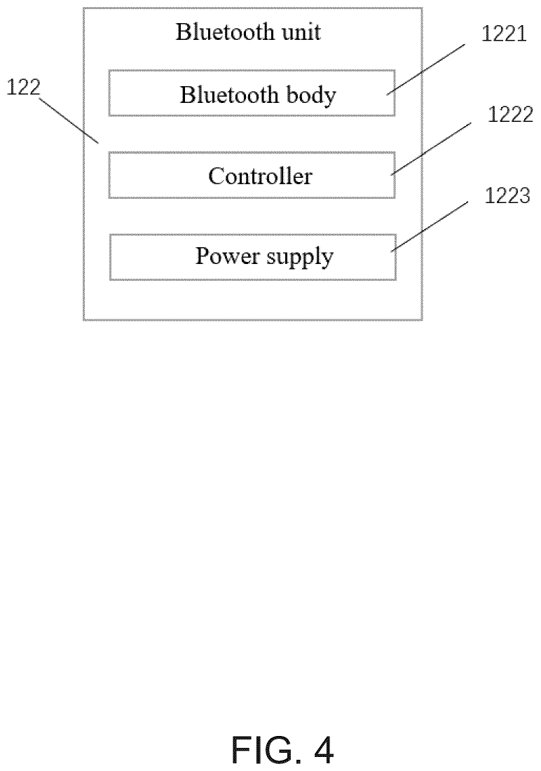

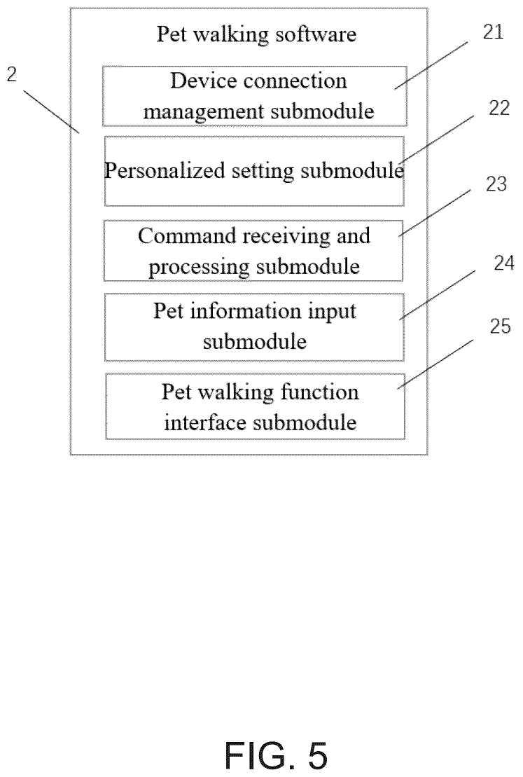

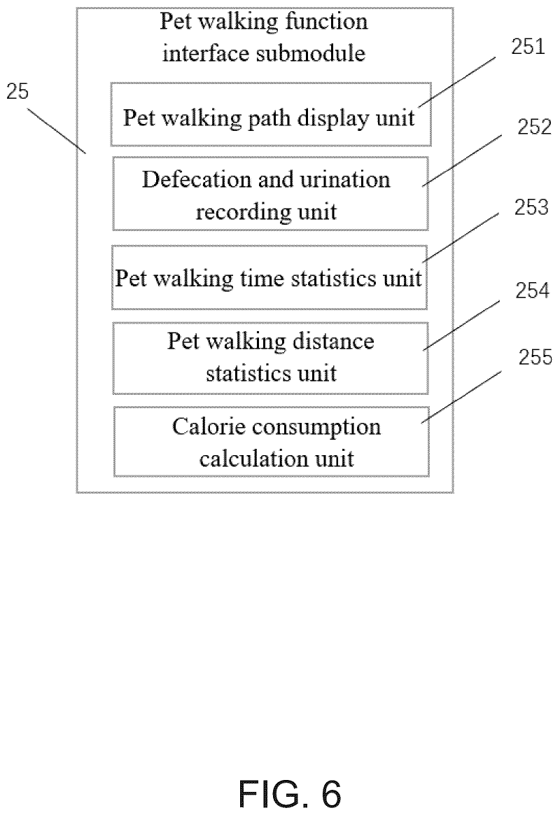

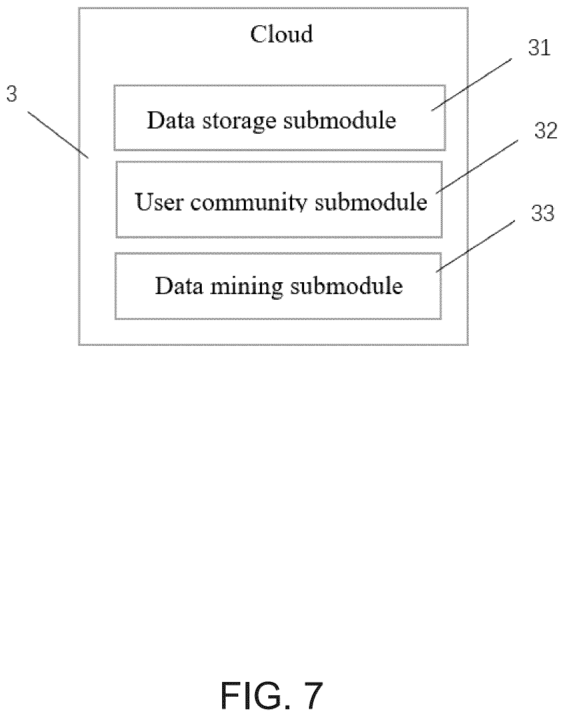

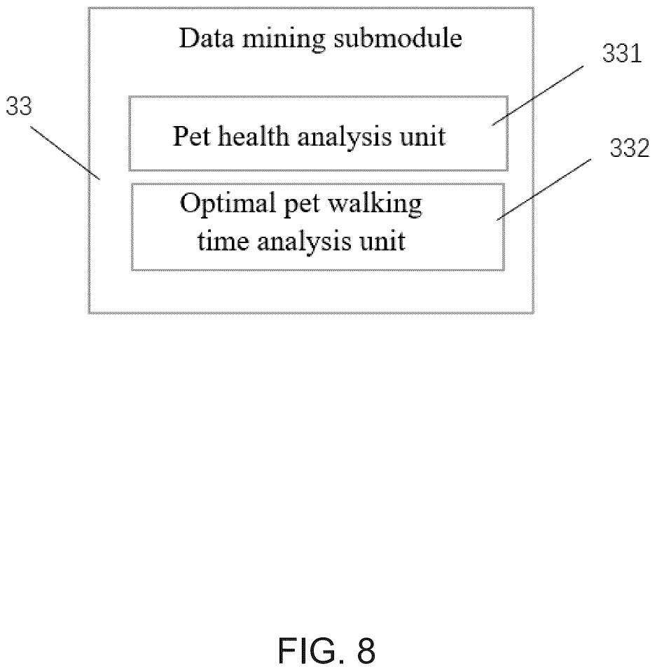

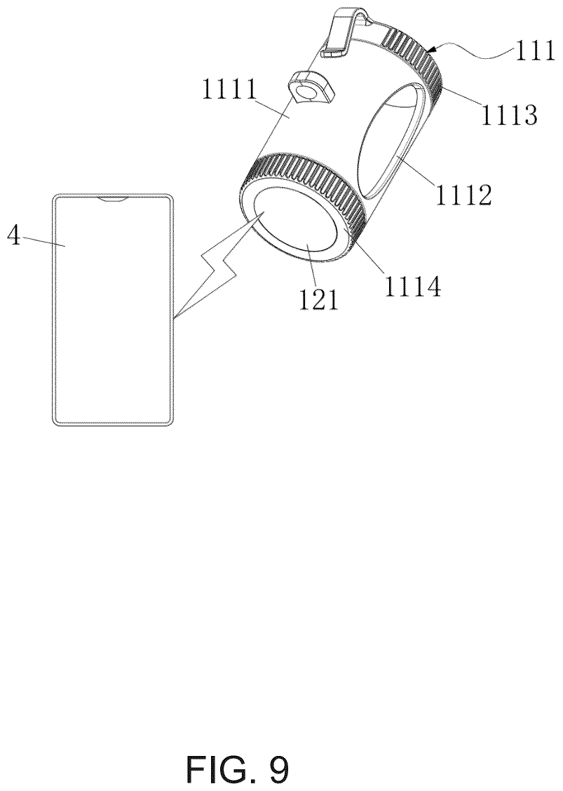

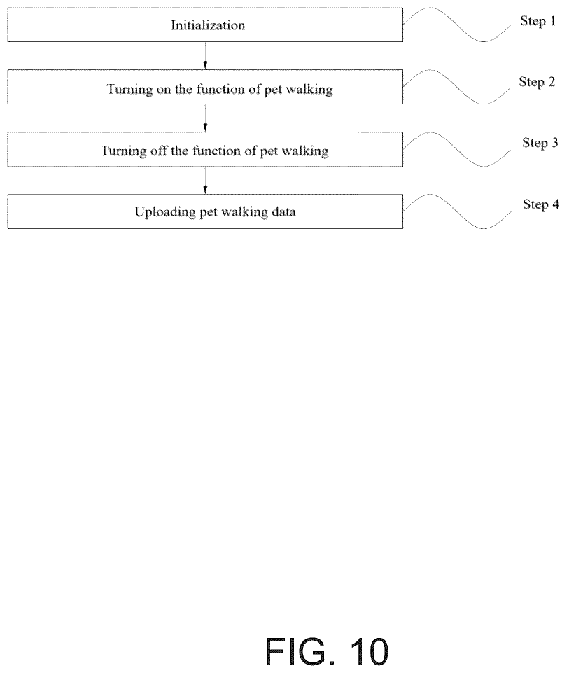

FIG. 1 to FIG. 10 show a technical solution provided by the present invention.

### Embodiment 1

An intelligent switching system for pet walking, comprising a hardware module 1, a pet walking software 2, a cloud 3 and a mobile terminal 4. The mobile terminal 4 is installed with the pet walking software 2 which establishes data connections with the hardware module 1 and the cloud 3 respectively. The hardware module 1 comprises a carrier submodule 11 and a multi-signal trigger submodule 12, and the multi-signal trigger submodule 12 is installed on the carrier submodule 11 and establishes data connections with the pet walking software 2. The mobile terminal 4 is used to install the pet walking software 2. The hardware module 1 is used to trigger the pet walking software 2, and the cloud 3 is used for data storage and analysis. The carrier submodule 11 is one of a waste bag dispenser 111, a pet leash 112 or a pet tag 113, and the waste bag dispenser 111 comprises a storage bin 1111, a material taking port 1112, a first end cap 1113 and a second end cap 1114, and the storage bin 1111 is provided with the material taking port 1112. One end of the storage bin 1111 is fixedly connected with the first end cap 1113, and the other end of storage bin 1111 is fixedly connected with the second end cap 1114. The storage bin 1111 is used to manage waste bags, and the material taking port 1112 is used to facilitate the removal of the waste bags. The first end cap 1113 and the second end cap 1114 are used to close the two ends of the storage bin 1111. The multi-signal trigger submodule 12 is one or more combinations of a NFC unit 121, a Bluetooth unit 122 and a QR code unit 123. The Bluetooth unit 122 comprises a Bluetooth body 1221, a controller 1222 and a power supply 1223. The power supply 1223 is used to power the Bluetooth body 1221 and the controller 1222, and the controller 1222 is used to generate different control signals. The pet walking software 2 comprises a device connection management submodule 21, a personalized setting submodule 22, a command receiving and processing submodule 23, a pet information input submodule 24 and a pet walking function interface submodule 25. The device connection management submodule 21 is used to establish the data connections with the multi-signal trigger submodule 12, and parse content of signal and obtain instructions. The personalized setting submodule 22 is used to personalize the pet walking software 2. The command receiving and processing submodule 23 is used to receive instructions parsed by the device connection management submodule 21, and perform links jump and control the pet walking function interface submodule 25. The pet information input submodule 24 is used to type in pet information, and the pet walking function interface submodule 25 is used to provide pet walking service. The pet walking function interface submodule 25 comprises a pet walking path display unit 251, defecation and a urination recording unit 252, a pet walking time statistics unit 253, a pet walking distance statistics unit 254 and a calorie consumption calculation unit 255. The pet walking path display unit 251 is used to display the pet walking path on electronic maps, defecation and the urination recording unit 252 is used to enter pet's defecation and urination information, the pet walking time statistics unit 253 is used to count pet walking time, the pet walking distance statistics unit 254 is used to count the pet walking distance, and the calorie consumption calculation unit 255 is used to calculate calories consumed by the pet. The cloud 3 is provided with a data storage submodule 31, a user community submodule 32 and data mining submodule 33. The data storage submodule 31 is used to store data, and user community submodule 32 is used to provide pet community forum services. The data mining submodule 33 is used to deeply excavate the data. The data mining submodule 33 comprises a pet health analysis unit 331 and an optimal pet walking time analysis unit 332, the pet health analysis unit 331 analyzes pet's health status through big data, and the optimal pet walking time analysis unit 332 generates recommendation on pet walking time based on pet's health status.

### Embodiment 2

An intelligently switching function of the pet walking, comprising step 1 which is initialization, step 2 which is turning on the function of pet walking, step 3 which is turning off the function of pet walking and step 4 which is uploading the pet walking data.

In the step 1, a pet walking software 2 is installed on a mobile terminal 4, an account is created and the pet information is registered in the pet walking software 2. The pet information comprises gender, age, type and weight.

In the step 2, the mobile terminal 4 is brought close to a waste bag dispenser 111 which equipped with an NFC unit 121, and a NFC service of the mobile terminal 4 sends a sensed start signal to the pet walking software 2, and the pet walking software 2 switches to a pet walking function interface submodule 25 which turns on the function of pet walking.

In the step 3, the mobile terminal 4 is brought close to the NFC unit 121 and kept for a pre-set time, and the NFC service of mobile terminal 4 sends the sensed end signal to the pet walking software 2, and the pet walking software 2 turns off the function of pet walking.

In the step 4, the pet walking software 2 automatically uploads pet walking data to the cloud 3 after function of pet walking is ended. The cloud 3 will store data, analyze health status of pets and best time for pet walking and simultaneously send analysis results to the mobile terminal 4.

### Embodiment 3

An intelligently switching function of the pet walking, comprising step 1 which is initialization, step 2 which is turning on the function of pet walking, step 3 which is turning off the function of pet walking and step 4 which is uploading pet walking data.

In the step 1, a pet walking software 2 is installed on a mobile terminal 4, an account is created and the pet information is registered in the pet walking software 2. The pet information comprises gender, age, type and weight.

In the step 2, a data connection is established between the mobile terminal 4 and a Bluetooth unit 122, and a start signal is sent to the mobile terminal 4 through a controller 1222 of the Bluetooth unit 122, and the pet walking software 2 switches to a pet walking function interface submodule 25 to turn on the function of pet walking.

In the step 3, the controller 1222 of the Bluetooth unit 122 sends end signal to the mobile terminal 4, and the pet walking software 2 turns off the function of pet walking.

In the step 4, the pet walking software 2 automatically uploads the pet walking data to the cloud 3 after function of pet walking is ended. The cloud 3 will store data, analyze health status of the pet and best time for pet walking, then send analysis results to the mobile terminal 4.

### Embodiment 4

An intelligently switching function of the pet walking, comprising step 1 which is initialization, step 2 which is turning on the function of pet walking, step 3 which is turning off the function of pet walking and step 4 which is uploading pet walking data.

In the step 1, a pet walking software 2 is installed on a mobile terminal 4, an account is created and the pet information is registered in the pet walking software 2. The pet information comprises gender, age, type and weight.

In step 2, the mobile terminal 4 scans a QR code unit 123 which contains the start instruction, and mobile terminal 4 sends scanned content to the pet walking software 2, and the pet walking software 2 switches to a pet walking function interface submodule 25 and a function of pet walking is turned on.

In step 3, the mobile terminal 4 scans the QR code unit 123 which contains the end instruction, and the mobile terminal 4 sends scanned content to the pet walking software 2, and the pet walking software 2 turns off function of pet walking.

In the step 4, pet walking software 2 automatically uploads the pet walking data to cloud 3 after the function of pet walking is ended. The cloud 3 will store data, analyze health status of the pet and best time for pet walking and simultaneously send analysis results to the mobile terminal 4.

### Embodiment 5

An intelligently switching function of the pet walking, comprising step 1 which is initialization, step 2 which is turning on the function of pet walking, step 3 which is turning off the function of pet walking and step 4 which is uploading pet walking data.

In step 1, a pet walking software 2 is installed on a mobile terminal 4, an account is created and the pet information is registered in the pet walking software 2. The pet information comprises gender, age, type and weight.

In step 2, the mobile terminal 4 scans a QR code unit 123 which contains a link to the pet walking software 2, mobile terminal 4 switches to a pet walking function interface submodule 25 of the pet walking software 2 after the scan, and the function of pet walking is turned on by function button on the pet walking function interface submodule 25.

In step 3, mobile terminal 4 scans QR code unit 123 which contains a link to the pet walking software 2, mobile terminal 4 switches to a pet walking function interface submodule 25 of the pet walking software 2 after the scan, and the function of pet walking is turned off by the function button on the pet walking function interface submodule 25.

In the step 4, the pet walking software 2 automatically uploads the pet walking data to the cloud 3 after function of pet walking is ended. The cloud 3 will store data, analyze health status of the pet and best time for pet walking and simultaneously send analysis results to mobile terminal 4.

The advantages of the present invention are when the present invention is used, the hardware module 1 can use the carrier submodule 11 to carry the multi-signal trigger submodule 12, the carrier submodule 11 can adopt one of waste bag dispenser 111, pet leash 112 or pet tag 113, and the multi-signal trigger submodule 12 can adopt one or more combinations of NFC unit 121, Bluetooth unit 122 as well as QR code unit 123. For example, when the waste bag dispenser 111 is used to carry the NFC unit 121, the NFC unit 121 can be installed on the second end cap 1114. The storage bin 1111 of the waste bag dispenser 111 is used to store waste bags. The material taking port 1112 is used to facilitate removal of waste bags. The first end cap 1113 and the second end cap 1114 are used to close two ends of the storage bin 1111. In the Bluetooth unit 122, the power supply 1223 is used to power the Bluetooth body 1221 as well as the controller 1222, which is used to generate the different control signals. When using the pet walking software 2, it needs to be downloaded on the mobile terminal 4 first. The download method is to go through the app store of the mobile terminal 4 or to jump to the download webpage through the multi-signal trigger submodule 12, then register and log in to the account on the pet walking software 2 and complete the pet information through the pet information input submodule 24. The pet information is uploaded to the data storage submodule 31 of the cloud 3, and is set through the personalized setting submodule 22, and data connection is established with the multi-signal trigger submodule 12 through the device connection management submodule 21. The multi-signal trigger submodule 12 sends a start signal to the device connection management submodule 21. The device connection management submodule 21 parses signal content, then obtains instruction and sends it to the command receiving and processing submodule 23. The command receiving and processing submodule 23 executes the instruction to control the start, pause or end of the pet walking function interface submodule 25. When the function of pet walking is ended, the pet walking data is automatically uploaded to the data storage submodule 31 of the cloud 3. The data mining submodule 33 uses the pet health analysis unit 331 to analyze pet health, and the optimal pet walking time analysis unit 332 generates recommendation on pet walking time based on health status of the pet and sends results to the mobile terminal 4, wherein the pet walking path display unit 251 is used to display pet walking path on the electronic map. The defecation and urination recording unit 252 is used to enter the pet defecation and urination information. The pet walking time statistics unit 253 is used to count pet walking time. The pet walking distance statistics unit 254 is used to count the pet walking distance. The calorie consumption calculation unit 255 is used to calculate the calories consumed by the pet, and the user community submodule 32 is used to provide a communication place for users.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

4. The intelligent switching system for pet walking according to claim 1, wherein the pet walking software comprises a device connection management submodule, a personalized setting submodule, a command receiving and processing submodule, a pet information input submodule and a pet walking function interface submodule, wherein the device connection management submodule is used to establish data connection with the multi-signal trigger submodule, parse the content of signal and obtain instructions, wherein the personalized setting submodule is used to personalize the pet walking software, wherein the command receiving and processing submodule is used to receive instructions parsed by the device connection management submodule, perform links jump and control the pet walking function interface submodule, wherein the pet information input submodule is used to type in the pet information, and wherein the pet walking function interface submodule is used to provide pet walking service.

6. A method for intelligently switching a pet walking function using the intelligent switching system of claim 1, the method comprising:
step 1 which is initialization, wherein the pet walking software is installed on the mobile terminal, an account is registered and logged in on the pet walking software, and then the pet information is completed in the step 1;
step 2 which is turning on the function of pet walking, wherein a data connection is established between the mobile terminal and the multi-signal trigger submodule, the multi-signal trigger submodule sends a start signal to the pet walking software, and then the pet walking software switches to the pet walking function interface submodule to start the function of pet walking;
step 3 which is turning off the function of pet walking, wherein a data connection is established between the mobile terminal and the multi-signal trigger submodule, the multi-signal trigger submodule sends an end signal to the pet walking software, and then the pet walking software ends the function of pet walking; and
step 4 which is uploading pet walking data, wherein the pet walking software automatically uploads the pet walking data to the cloud after the function of pet walking ends.
